(19) United States
(12) Patent Application Publication
(10) Pub. No.: US 2006/0125844 A1
(43) Pub. Date: Jun. 15, 2006

(54) Method of automatically processing an image and an apparatus using the method

(75) Inventors: Jun Hasegawa, Suwon-si (KR); Tae-Yoon Hwang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/181,790

(22) Filed: Jul. 15, 2005

(30) Foreign Application Priority Data
Dec. 9, 2004 (KR) 10-2004-0103656

(51) Int. Cl. G09G 5/00

(52) U.S. Cl. 345/619; 715/700

(57) ABSTRACT

An apparatus and method for automatically processing an image that displays changes to the image at the back of a display region on a window of the foremost software are provided. The method of automatically processing an image uses automatic image processing software which is executed in a graphical user interface (GUI) operating system which displays a plurality of windows on a monitor screen. The apparatus and method include capturing the image at the back of a display region on a window of the automatic image processing software; automatically performing a specific image process on the captured image; and displaying the processed image on the display region.

This application claims the benefit under 35 U.S.C. 119(a) of Korean Patent Application No. 10-2004-0103656, filed on Dec. 9, 2004, in the Korean Intellectual Property Office, the disclosure of which is incorporated herein in its entirety by reference.

### BACKGROUND OF THE INVENTION

1. Field of the Invention

The present invention relates to a method of automatically processing an image, and an apparatus using the method. More particularly, the present invention relates to a method of automatically processing an image that displays changes to the image located at the back of a display region on a window of the foremost-located software, and an apparatus using the method.

2. Description of the Related Art

FIG. 1 is a diagram illustrating a conventional monitor screen that displays windows. The term “windows” is used as understood with reference to well known windows graphical user interfaces (GUI's), such as, the Microsoft Windows operating system. Referring to FIG. 1, a background image 102, icons 103, and window displays 104 and 105 are displayed on the monitor screen 101. Since each of the applications displays a different window, applications have a different function of displaying the respective window. For example, some professional level applications are able to simulate and display a print color on a monitor. Other inexpensive applications, i.e., Microsoft Office applications, cannot simulate the print color but can preview a screen layout on the monitor while approximating print colors of the image. In addition to simulating the print color, an application specification determines whether to perform image processing.

In the conventional art, when an application is incapable of simulating the print color, the image processing must be manually performed using another application capable of processing bitmap data by copying image data that displays a target window to a clipboard as bitmap data, using a screen capture function performed in the operating system.

However, the conventional art requires an expensive application having change and image processing functions, and a manual operation and time as well, in order to simulate the print color. The conventional art can not automatically simulate the print color and thus is inconvenient and impractical. Therefore, a method of automatically and conveniently processing the image at high speed is necessary.

U.S. Pat. No. 6,151,135, which is incorporated herein by reference discloses an apparatus for controlling a color signal using a lookup table.

Therefore, there is a need for an economical means for automatically simulating a print color that does not require manual intervention.

### SUMMARY OF THE INVENTION

The present invention provides a method of automatically processing an image that displays an image-processed result on a predetermined region designated by a user on a whole monitor screen automatically and in real time, and simulates and displays a print color on a monitor.

The present invention also provides an apparatus for automatically processing an image that displays an image-processed result on a predetermined region designated by a user in a whole monitor screen automatically and in real time, and simulates and displays a print color on a monitor.

According to an aspect of the present invention, there is provided a method of automatically processing an image using automatic image processing software which is executed in a graphical user interface (GUI) operating system which displays a plurality of windows on a monitor screen. The method comprising (a) capturing the image located at the back of a display region on a window of the automatic image processing software; (b) automatically performing a specific image process on the captured image; and (c) displaying the processed image on the display region.

According to another aspect of the present invention, there is provided an apparatus for automatically processing an image using automatic image processing software which is executed in a GUI operating system which displays a plurality of windows on a monitor screen. The apparatus comprising an image capture unit which captures the image at the back of a display region on a window of the automatic image processing software; an image processing unit which automatically performs a specific image process on the captured image; and a display unit which displays the processed image on the display region.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional monitor screen that displays Windows;

FIG. 2 is a flow chart illustrating a method of automatically processing an image according to an embodiment of the present invention;

FIG. 3 is a block diagram illustrating an apparatus for automatically processing the image according to an embodiment of the present invention;

FIG. 4 is a diagram illustrating a window of automatic image processing software according to an embodiment of the present invention;

FIG. 5 is a block diagram illustrating an event recall of the window of the automatic image processing software according to an embodiment of the present invention; and

FIG. 6 is a flow chart illustrating the event recall of the window of the automatic image processing software according to an embodiment of the present invention.

Throughout the drawings, the same or similar elements are denoted by the same reference numerals.

### DETAILED DESCRIPTION OF EXEMPLARY EMBODIMENTS OF THE INVENTION

Hereinafter, exemplary embodiments of the present invention will now be described more fully with reference to the accompanying drawings.

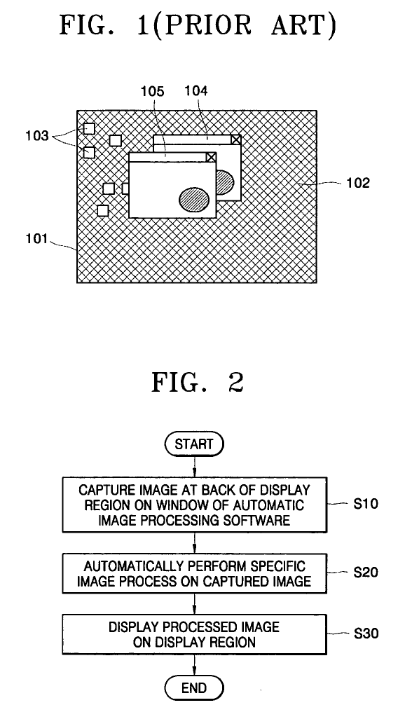

FIG. 2 is a flow chart illustrating a method of automatically processing an image according to an embodiment of the present invention. Referring to FIG. 2, the method of automatically processing the image uses automatic image processing software that is executed in a graphical user interface (GUI) operating system which displays a plurality of windows on a monitor screen.

An image located at the back of a display region on a window of the automatic image processing software is captured at step S10. A specific image process is automatically performed on the captured image at step S20. The processed image is displayed on the display region at step S30.

When the window of the automatic image processing software is moved or resized due to a mouse operation, an event is indicated and the image at the back of the display region is captured at step S10. Herein, the term “event” is defined as every event that occurs in Windows, that is, for example, clicking on an icon with a mouse, opening a window, or invoking a program and so on. When the event is indicated, the display region is established as transparent while the window of the automatic image processing software is moved or resized, and after the window is moved or resized, the image at the back of the transparent display region is captured at step S10.

The display region is established as opaque, and the image obtained after the specific image process is performed on the image at the back of the opaque display region is displayed on the display region at step S30.

The specific image process includes a color change process necessary for displaying a print color on a monitor. In order to perform the color change process, red, green, blue (RGB) values of the captured image are used to calculate a three-dimensional linear interpolation based on a three-dimensional lookup table at step S20.

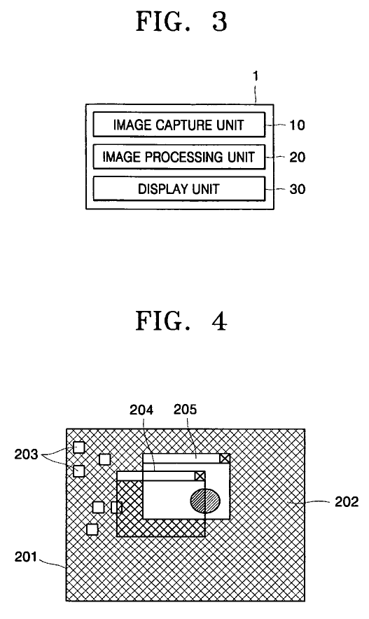

FIG. 3 is a block diagram illustrating an apparatus for automatically processing an image according to an embodiment of the present invention. Referring to FIG. 3, the apparatus 1 for automatically processing the image uses the automatic image processing software that is executed in the GUI operating system which displays the plurality of windows on the monitor screen, and comprises an image capture unit 10, an image processing unit 20, and a display unit 30.

The image capture unit 10 captures the image at the back of the display region on the window of the automatic image processing software. The image processing unit 20 automatically performs a specific image process on the captured image. The display unit 30 displays the processed image on the display region.

When the window of the automatic image processing software is moved or resized due to a mouse operation, the image capture unit 10 captures the image at the back of the display region. The image capture unit 10 establishes the display region as transparent while the window of the automatic image processing software is moved or resized, and captures the image at the back of the transparent display region after the window is moved or resized.

The display unit 30 establishes the display region as opaque, and displays the image obtained after the specific image process is performed on the image at the back of the opaque display region on the display region.

The specific image process comprises a color change process necessary for displaying a print color on a monitor. In order to perform the color change process, the image processing unit 20 inputs RGB values of the captured image and calculates the three-dimensional linearity interpolation using the three-dimensional lookup table.

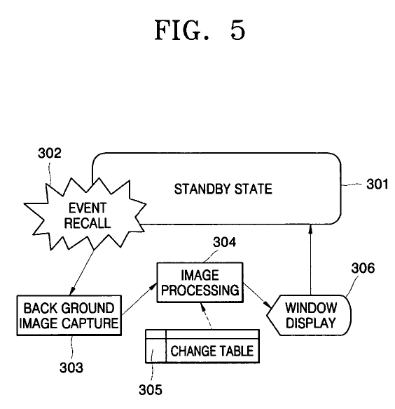

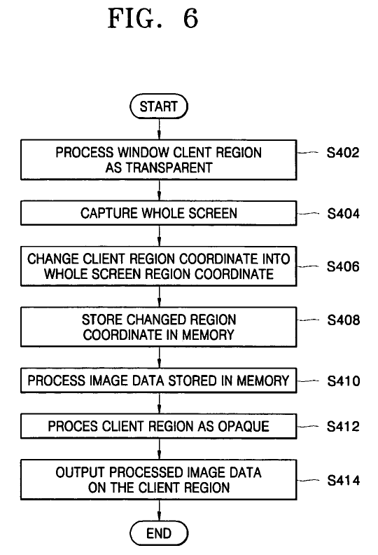

FIG. 4 is a diagram illustrating the window of the automatic image processing software according to an embodiment of the present invention. Referring to FIG. 4, a background image 202, icons 203, a window display unit 204 of the automatic image processing software, and a window display unit 205 of another application are displayed on a whole screen 201. FIG. 5 is a block diagram illustrating an event recall of the window of the automatic image processing software according to an embodiment of the present invention. FIG. 6 is a flow chart illustrating the event recall of the window of the automatic image processing software according to an embodiment of the present invention. Referring to FIGS. 4 through 6, a method of automatically processing the image according to an embodiment of the present invention will now be described. Herein, the term “event recall” refers to displaying a window again, that is, for example, maximizing a window, minimizing a window, or converting an inactive window into an active window and so on.

A method of checking a result obtained by automatically performing a specific image process on an image on a window screen of an application without a separate operation at any time will now be described.

Referring to FIG. 5, a standby state 301 corresponds to a message loop operation in an event-driven operating system. When the automatic image processing message is notified of the event recall 302 from the event-driven operating system, the automatic image processing software starts the automatic image process. A screen display image at the back of the present display region of the window of the automatic image processing software is not separated into the background image 202, icons 203, and the window display unit 205, but is captured as one image (303). The specific image process is performed (304). When the print color simulation is performed, new RGB values are calculated for each pixel. More specifically, the new RGB values are calculated taking into consideration the speed required to perform the print color simulation using the three-dimensional linearity interpolation based on the three-dimensional lookup table. A change table 305 corresponds to the three-dimensional lookup table. The three-dimensional lookup table can be written based on a previously calculated color change. An international color consortium (ICC) profile is widely used to calculate the color change.

The image based on the calculated RGB values is displayed on the window of the automatic image processing software (306). The image automatic processing is completed at the standby state 301.

The event is used to determine timing for performing the image automatic processing according to the specification of an event comprising the operating system.

In one example, Microsoft Windows 2000 or Windows XP make the display region of the window, that is, a client region, completely transparent while the window of the automatic image processing software is moved or resized due to the mouse operation, such as a “click-and-drag” operation, or the like. The method captures a screen image located at the back of the transparent window at the moment of determining to move or resize the window by, for example, releasing the mouse button, performs the image processing, makes the client region opaque, and displays the processed image result.

Embedded software using Microsoft Foundation Class (MFC) C++ in the Windows 2000 and Windows XP operating system will now be described as an example. Referring to FIG. 6, the window client region is processed as transparent at step S402, and a whole screen is captured at step S404. A client region coordinate is changed into a whole screen region coordinate at step S406, and the changed region coordinate is stored in memory at step S408. Image data stored in the memory is processed at step S410, and the client region is processed as opaque at step S412. The processed image data is output on the client region at step S414.

An exemplary program written in Visual C++7.0 will now be described. The program comprises the steps of FIG. 6, and its internal code uses MFC and application program interface (API).

First, the program is configured as a multiple document interface (MDI) of MFC.

The window size determined in operating the program is reduced by changing values cx and cy of a CREATESTRUCT structure of PreCreateWindow (CREATESTRUCT& cs) of a MainFrame Class.

```
BOOL CMainFrame::PreCreateWindow(CREATESTRUCT& cs)
{
    if( !CFrameWnd::PreCreateWindow(cs) )
        return FALSE;
    cs.cx = 300 ;
    cs.cy = 300 ;
    return TRUE;
    }
```

Two region objects are used to make the client region, that is, a window display region, transparent. The whole screen and the client region are established in two region objects. The transparent client region is obtained by performing an exclusive OR operation. When the window is created, moved, or resized, the transparent region is created, which is performed in the MainFrame Class since the creation of the transparent client region is related to a window frame.

```
CRgn g_rgnWnd , g_rgnWnd2 ;
..................
void CMainFrame::OnSize(UINT nType, int cx, int cy)
void CMainFrame::OnMove(int x, int y)
void CMainFrame::OnCaptureChanged(CWnd *pWnd)
{
  .................
  GetClientRect(&rcClient) ;
  GetWindowRect(&rcScreen) ;
  ClientToScreen(&rcClient) ;
  if ( (HRGN)g_rgnWnd != NULL)
    g_rgnWnd.DeleteObject( ) ;
  if ( (HRGN)g_rgnWnd2 != NULL)
    g_rgnWnd2.DeleteObject( ) ;
  g_rgnWnd2.CreateRectRgn(rcClient.left − rcScreen.left,
  rcClient.top − rcScreen.top,
  rcClient.right − rcScreen.left, rcClient.bottom − rcScreen.top) ; (1)
  g_rgnWnd.CreateRectRgn(0 , 0 , rcScreen.Width( ),
  rcScreen.Height( ));(2)
  g_rgnWnd.CombineRgn(&g_rgnWnd2, &g_rgnWnd,
  RGN_XOR); (3)
  SetWindowRgn((HRGN)g_rgnWnd,true) ; (4)
}
```

In the program, (1) indicates the client region, (2) indicates the whole screen region, (3) indicates the exclusive OR operation of the client region and the whole screen region, and (4) indicates validation of the exclusive OR operation of the client region and the whole screen region.

A region size is limited only to the client region except a title bar, a menu bar, and a boundary line.

When the mouse button is released, the client region of the corresponding location is captured to make the transparent region opaque.

```
void CFrameWnd::OnCaptureChanged(CWnd *pWnd)
{
  CFrameWnd::OnCaptureChanged(pWnd);
  CNewCapture6View* pView ;
  pView =  (CPrevieScopeView *)GetActiveView( ) ;
  pView->OnCaptureBegin( ) ; (5)
  OnUndoTransparent( ); (6)
  }
```

In the program, (5) indicates beginning to capture an image, and (6) indicates reverting the transparent region to opaque.

The image is captured in a view class. A BITMAPINFOHEADER is created to obtain a bitmap of the captured image, and the bitmap is created using a CreateDIBSection function. The created bitmap is stored in memory and used to display an image-processed screen after making the client region opaque. The view class is used to display the captured image on the screen.

```
void CPrevieScopeView::OnCaptureBegin( )
{
    UINT i, j ;
GetClientRect(&rcScreen) ;  // size of the present window client region
    rcClient = rcScreen ;
    ClientToScreen(&rcScreen) ;
    WORD width,height;
    width = rcClient.Width( );
    height = rcClient.Height( );
    memset ( &bmi, 0, sizeof(BITMAPINFO) );
    // BITMAPINFOHEADER setting, this information must be set up
    // based on whole screen information and client region information
    bmi.bmiHeader.biSize = sizeof(BITMAPINFOHEADER);
    bmi.bmiHeader.biWidth = width ;
    bmi.bmiHeader.biHeight = height ;
    bmi.bmiHeader.biPlanes = 1 ;
    bmi.bmiHeader.biBitCount = 24 ;
    bmi.bmiHeader.biCompression = BI_RGB;
    // creating of bitmap using BITMAPINFORHEADER
    hMyBitmap = CreateDIBSection(hMemDC, &bmi,
DIB_PAL_COLORS, &pBuf, NULL, 0) ;
    hOldBitmap = (HBITMAP)SelectObject(hMemDC, hMyBitmap) ;
    BitBlt(hMemDC, 0, 0, width , height, hDesktopDC, rcScreen.left,
rcScreen.top, SRCCOPY) ;
    GetObject(hMyBitmap, sizeof(BITMAP), &bmp) ;
    DWORD offset;
    BYTE* buf = (BYTE*)(pBuf);
    for( j = 0 ; j < height ; j++ )
      for ( i = 0 ; i < width ; i++ )
      {
        offset = j*bmp.bmWidthBytes+i*3;
        // processing of captured image
        buf[offset] = (BYTE)(buf[offset]*0.6);
        buf[offset+1] = (BYTE)(buf[offset+1]*0.9);
        buf[offset+2] = (BYTE)(buf[offset+2]*0.8);
  }
}
```

Image-processed data is stored in the memory. The transparent region should be changed into the opaque region in order to display the image-processed data.

```
void CMainFrame::OnUndoTransparent ( )
{  GetClientRect(&rcClient) ;
      GetWindowRect(&rcScreen) ;
ClientToScreen(&rcClient) ;
      // when previous data still exists, the previous data is removed.
      if ( (HRGN)g_rgnWnd != NULL)
          g_rgnWnd.DeleteObject( ) ;
      if( (HRGN)g_rgnWnd2 != NULL)
          g_rgnWnd2.DeleteObject( ) ;
      g_rgnWnd2.CreateRectRgn(rcClient.left − rcScreen.left,
      rcClient.top − rcScreen.top,
      rcClient.right − rcScreen.left, rcClient.bottom − rcScreen.top) ;
      g_rgnWnd.CreateRectRgn(0 , 0 , rcScreen.Width( ),
      rcScreen.Height( ));
      g_rgnWnd.CombineRgn(&g_rgnWnd2, &g_rgnWnd,
      RGN_OR);
      SetWindowRgn((HRGN)g_rgnWnd,true) ;
}
```

As described above, the whole screen and the client region are established as region objects, and an OR operation is performed. The transparent region is changed into the opaque region. The data stored in memory is displayed on the client region.

void CPreviewScopeView::OnPaint( )

{

CPaintDC dc(this); // device context for painting

BitBlt(dc, 0, 0, bmp.bmWidth, bmp.bmHeight, hMemDC, 0, 0, SRCCOPY);

SelectObject(hMemDC, hOldBitmap);

}

A BitBIt function is used to copy data stored in the memory to the client region.

The above processes are repeated when the window is again moved or resized. An image in the client region is captured and an image-processed background screen is shown in the client region. The exemplary embodiment of the present invention described herein is based on but not limited to an event-driven operating system.

The exemplary embodiment of the present invention makes it possible to quickly and automatically display changes to the image on the window of predetermined software being executed on the monitor on a predetermined window region designated by a user.

In particular, exemplary embodiments of the present invention make it possible to easily check the result of a color change simulation and improve user convenience when the image processing comprises color change processing.

Embodiments of the present invention make it possible to simulate the print color without performing a separate operation, even when the application used is incapable of print color simulation.

While an embodiment of the present invention has been particularly shown and described, it will be understood by those of ordinary skill in the art that various changes in form and details may be made therein without departing from the spirit and scope of the present invention as defined by the following claims.

What is claimed is:

1. A method of automatically processing an image using automatic image processing software which is executed in a graphical user interface (GUI) operating system which displays a plurality of windows on a monitor screen, the method comprising:
(a) capturing the image located at the back of a display region on a window of the automatic image processing software;
(b) automatically performing a specific image process on the captured image; and
(c) displaying the processed image on the display region.

2. The method of claim 1, wherein operation (a) comprises:
when the window of the automatic image processing software is moved or resized due to a mouse operation, generating an event notification and capturing the image at the back of the display region.

3. The method of claim 2, wherein operation (a) further comprises:
when the event notification is generated, establishing the display region as transparent while the window of the automatic image processing software is moved or resized, and after the window is moved or resized, capturing the image at the back of the transparent display region.

4. The method of claim 3, wherein operation (c) comprises:
establishing the display region as opaque, and displaying an image obtained after the specific image process is performed on the image, at the back of the opaque display region on the display region.

5. The method of claim 1, wherein in operation (b), the specific image process comprises a color change process necessary for displaying a print color on a monitor.

6. The method of claim 5, wherein operation (b) further comprises:
in order to perform the color change process, inputting red, green, blue (RGB) values of the captured image, and calculating a three-dimensional linearity interpolation based on a three-dimensional lookup table.

7. An apparatus for automatically processing an image using automatic image processing software which is executed in a graphical user interface (GUI) operating system which displays a plurality of windows on a monitor screen, the apparatus comprising:
an image capture unit for capturing the image at the back of a display region on a window of the automatic image processing software;
an image processing unit for automatically performing a specific image process on the captured image; and
a display unit for displaying the processed image on the display region.

8. The apparatus of claim 7, wherein the image capture unit captures the image at the back of the display region when the window of the automatic image processing software is moved or resized due to a mouse operation.

9. The apparatus of claim 8, wherein the image capture unit establishes the display region as transparent while the window of the automatic image processing software is moved or resized, and captures the image at the back of the transparent display region after the window is moved or resized.

10. The apparatus of claim 9, wherein the display unit establishes the display region as opaque, and displays an image obtained after the specific image process is performed on the image at the back of the opaque display region on the display region.

11. The apparatus of claim 7, wherein the specific image process comprises a color change process necessary for displaying a print color on a monitor.

12. The apparatus of claim 11, wherein the image processing unit inputs the RGB values of the captured image, and calculates a three-dimensional linearity interpolation based on a three-dimensional lookup table in order to perform the color change process.

13. A computer readable medium of instructions for automatically processing an image using automatic image processing software which is executed in a graphical user interface (GUI) operating system which displays a plurality of windows on a monitor screen, the method comprising:
a first set of instructions adapted to capture the image located at the back of a display region on a window of the automatic image processing software;
a second set of instructions adapted to automatically perform a specific image process on the captured image; and
a third set of instructions adapted to display the processed image on the display region.

14. A computer readable medium of instructions as in claim 13, wherein said first set of instructions is further adapted to generate an event notification and capture the image at the back of the display region when the window of the automatic image processing software is moved or resized due to a mouse operation.

15. A computer readable medium of instructions as in claim 14, wherein said first set of instructions is further adapted to establish the display region as transparent while the window of the automatic image processing software is moved or resized, and after the window is moved or resized, capture the image at the back of the transparent display region when the event notification is generated.

16. A computer readable medium of instructions as in claim 15, wherein said third set of instructions is further adapted to establish the display region as opaque, and display an image obtained after the specific image process is performed on the image, at the back of the opaque display region on the display region.

17. A computer readable medium of instructions as in claim 13, wherein in said second set of instructions the specific image process comprises a color change process necessary for displaying a print color on a monitor.

18. A computer readable medium of instructions as in claim 17, wherein said second set of instructions is further adapted to input red, green, blue (RGB) values of the captured image, and calculate a three-dimensional linearity interpolation based on a three-dimensional lookup table in order to perform the color change process.
